(19) United States
(12) Patent Application Publication
(10) Pub. No.: US 2008/0035035 A1
(43) Pub. Date: Feb. 14, 2008

(54) Security unit

(76) Inventor: Suzanna L. Stone, Moreland Hills, OH (US)

Correspondence Address: CURATOLO SIDOTI CO., LPA, 24500 CENTER RIDGE ROAD, SUITE 280, CLEVELAND, OH, 44145, US

(21) Appl. No.: 11/891,454

(22) Filed: Aug. 10, 2007

Related U.S. Application Data
(60) Provisional application No. 60/837,163, filed on Aug. 11, 2006.

(51) Int. Cl. E05G 1/00

(52) U.S. Cl. 109/1 R; 206/503; 220/315

(57) ABSTRACT

Provided is a security unit comprising at least one security container conjoined to at least one appliance unit. A security container comprises a base, a closure, and an engagement element. The closure is affixable to the base and is lockably and releaseably attached to the base by an engagement element. The appliance unit may be any common appliance including, but not limited to a refrigerator. The security unit is optionally fireproof and waterproof.

### CROSS REFERENCE TO RELATED APPLICATIONS

This application claims the benefit of the filing date under 35 U.S.C. §119(e) from United States Provisional Application For Patent Ser. No. 60/837,163 filed on Aug. 11, 2006.

### TECHNICAL FIELD

Disclosed is a security unit whereby valuable items may be safely and securely stored. The security unit comprises a security container that is conjoined with an appliance unit. The security unit provides the owner with easy access to the contents of the security container, but minimizes or prevents theft of the security container or the contents contained within the security container.

### BACKGROUND

Many people own valuable items such as cash, jewelry, valuable documents, such as deeds, insurance policies, stock certificates, and the like. Frequently, such valuable items are targets of theft. The problem of theft remains of continuing concern to the population, especially in apartment buildings and university dormitories.

In order to prevent theft, many people chose to store valuable items in a manner to discourage and delay unauthorized access to the items. One such method to discourage and delay unauthorized access to the items is to store them in security containers. Security containers are containers into which items may be placed, and which are secured in a closed state to prevent the removal of said items from the container. The security measures existing on a security container are intended to frustrate unauthorized attempts to open the security container and remove the items stored therein. The frustration is the result of the great time and effort needed to circumvent the security measures to gain access to the contents of the security container.

A common step in circumventing the security measures of the security container to open the security container, and thereby gaining access to the items stored therein, is to remove the security container intact to a different working location where different facilities or a decreased likelihood of detection are more agreeable to the unauthorized actor. Removing the security container to another location provides the unauthorized actor with greater opportunities, such as greater time, greater secrecy, and greater access to tools, to circumvent the security measures of the security container.

Preventing the removal of a security container from the owner-elected location is desirable in order to discourage theft of valuable items. One method of preventing the removal of a security container is to secure the security container in a structure or fixture. For example, security containers may be stored in safes, or lockers, or automobiles. Some security containers are equipped wraith secure connection devices to allow the connection chains or cables that may be used to secure the security container to more diverse items such as railings, posts, or beams. Such securing methods use large-clearance connections and improvised security tie-in points which are weaknesses for exploitation by the unauthorized actor.

It remains desirable to provide a secure container, which can be readily accessed as a standard security container, but which is difficult to remove from a heavy or bulky item to which it is designed to be intimately secured.

### SUMMARY

Provided is a security unit comprising at least one security container and at least one appliance unit conjoined with said security container.

According to certain illustrative embodiments, the security unit comprises at least one security container conjoined with a refrigerator.

According to additional illustrative embodiments, the security unit comprises two security containers conjoined with an appliance unit.

According to further illustrative embodiments, the security unit comprises two security containers conjoined with a refrigerator.

### BRIEF DESCRIPTION OF THE DRAWINGS

FIG. 1 is a schematic representation of one illustrative embodiment of a security container mounted in conjunction with a refrigerator.

FIG. 2 is a schematic representation of the security container shown in FIG. 1 with the security container closure in the open position.

FIG. 3 is a schematic representation of another illustrative embodiment of the security container mounted in conjunction with a refrigerator.

FIG. 4 is a schematic representation of the security container shown in FIG. 3 with the security container closure in the open and detached position.

FIG. 5 is a schematic representation of a further illustrative embodiment of the security container mounted in conjunction with a microwave oven.

FIG. 6 is a schematic representation of the security container shown in FIG. 5 with the security container closure in the open position.

FIG. 7 is a schematic representation of another illustrative embodiment of the security container mounted in conjunction with a refrigerator.

FIG. 8 is a schematic representation of the security container shown in FIG. 7 with the security container closure in the open position.

### DETAILED DESCRIPTION

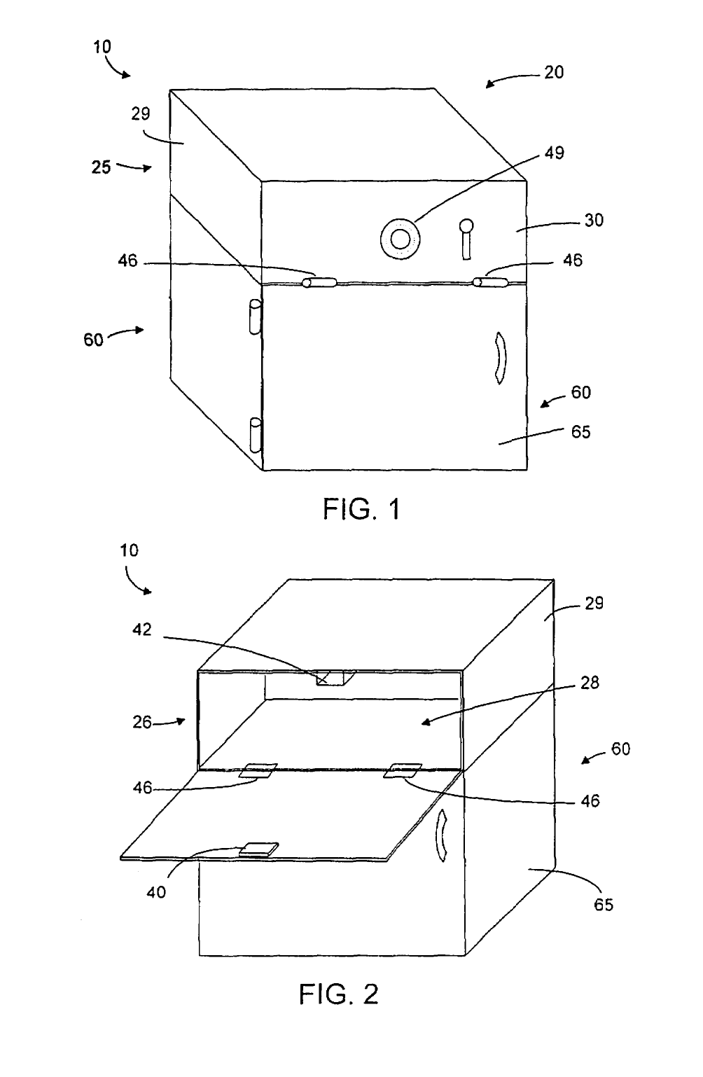

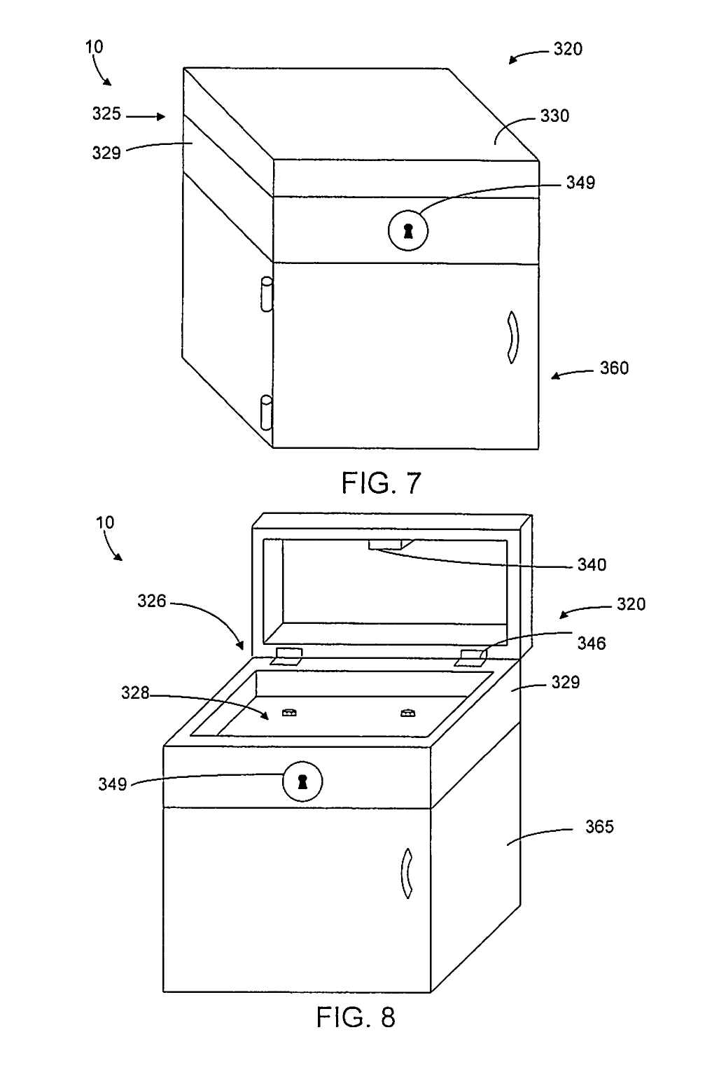

The security unit will be described in connection with FIGS. 1 through 8. It should be noted that the security unit is not limited to the illustrative embodiments shown in FIGS. 1 through 8, but should be construed in accordance with the appended claims. It is to be understood that throughout the FIGS that like elements are denoted by like numerals, unless otherwise designated.

According to FIGS. 1 through 8, a security unit (10) is provided. The security unit comprises a security container (20, 120, 220, 320), an appliance (60, 160, 260, 360), and means for connecting the security container (20, 120, 220, 320) and the appliance (60, 160, 260, 360) into a single conjoined security unit.

Referring to FIGS. 1 through 8, the security container (20, 120, 220, 320) itself comprises a base (25, 125, 225, 325), a closure (30, 130, 230, 330), and an engagement element (40, 140, 240, 340). The base (25, 125, 225, 325) is a hollow container connected to its environment through an opening (26, 126, 226, 326). Objects to be secured within the security container (20, 120, 220, 320) are passed through the opening (26, 126, 226, 326) and placed in the interior (28, 128, 228, 328) of the base (25, 125, 225, 325). Because the security container (20, 120, 220, 320) is to be secure against intentional and accidental access to the interior, the base walls (29, 129, 229, 329) should comprise durable materials. Such durable materials are those having properties which have the desired resistance to the anticipated harm. Without limitation, types of harm commonly secured against include tampering, breaking, fire, flooding or other harm. Without limitation, materials acceptable for use as the base material include steel, aluminum, aluminum alloys, polymers, composite materials, concrete, and wood.

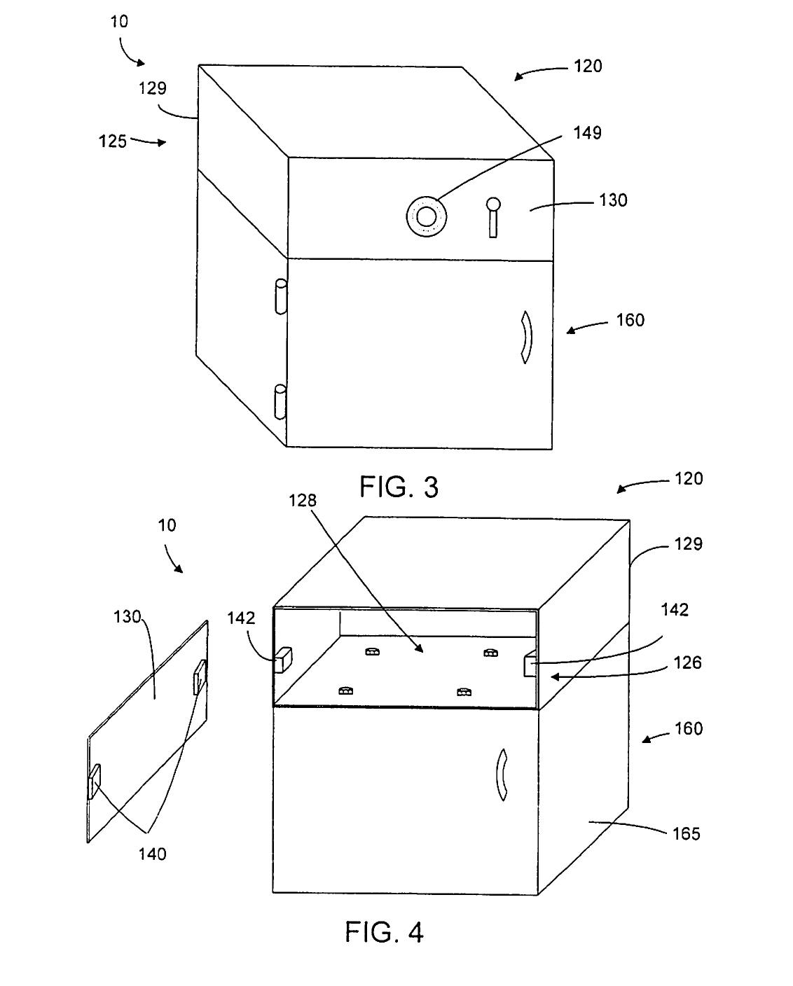

Referring to FIGS. 1 through 8, the closure (30, 130, 230, 330) is affixable to said base (25, 125, 225, 325). Referring to FIGS. 3 and 4, the closure (130) may be removably affixable. A removably affixable closure (130) may be entirely detached from the base when open. Without limitation, this type of affixation may be achieved by using a plurality of engagement elements (140). In certain embodiments, one or more engagement elements (140) are located on various edges of the closure. In this embodiment, when in the closed position, the engagement element (140) insert into or around counterpart elements (142) attached to the base (125). When so inserted, the engagement elements (140) hold the closure (130) in place, securing the security container (120). Withdrawal of the engagement elements (140) allows the closure (130) to be removed entirely from the base (125), exposing the interior (128) of the base (125).

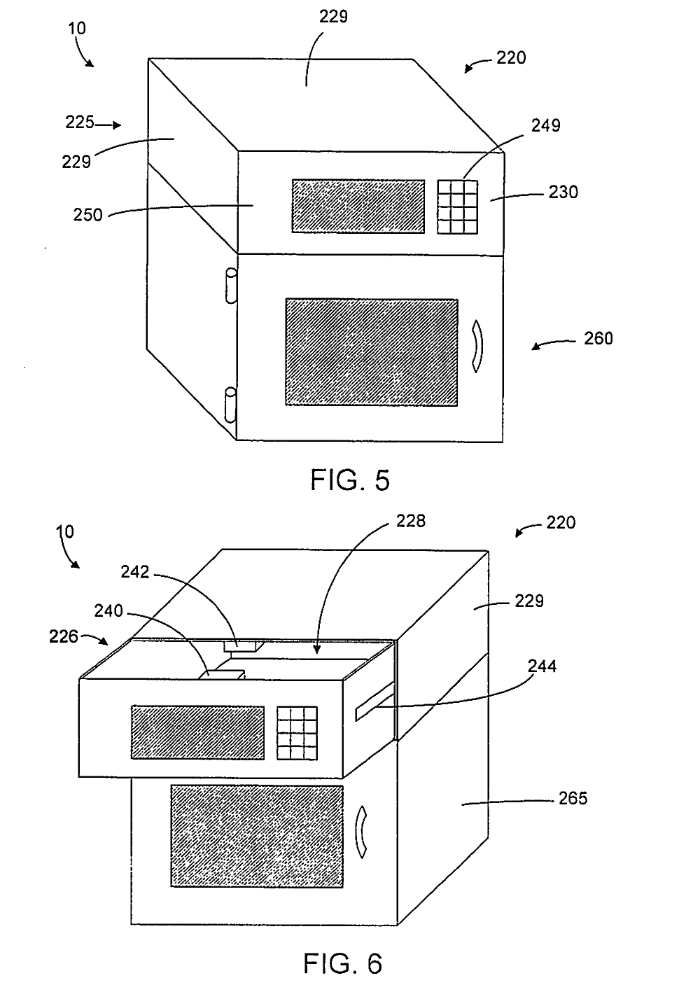

Referring to FIGS. 1, 2, 5, 6, 7, and 8, the closure (30, 230, 330) may also be non-removably affixable. A non-removably affixable closure (30, 230, 330) remains attached to the base (25, 225, 325) in some way even when the security container (20, 220, 320) is open. Referring to FIGS. 5 and 6, in certain embodiments, non-removable affixation may be achieved by using sliding mechanisms (244) or tracks to allow the closure to open in the manner of operation of a drawer. A sliding mechanism is one which allows one link of the mechanism to slide with respect to other links of the mechanism. Without limitation, a simple sliding mechanism is a track. Where a sliding mechanism (244) or track is used to attach the closure (230) to the base (225), a second engagement element (240) may be used to secure the closure (230) in a closed position and prevent unwanted sliding out of position.

Referring to FIGS. 1, 2, 7, and 8, in some embodiments, non-removable affixation may be achieved by using rotating mechanisms (46, 346) or hinges. A rotating mechanism is one which allows one link of the mechanism to rotate with respect to other links of the mechanism. Without limitation, a simple rotating mechanism is a hinge. In certain embodiments, one or more rotating mechanisms (46, 346) are located on one edge of the closure (30, 330), said rotating mechanisms (46, 346) allow the closure (30, 330) to rotate into and out of the position it occupies when the security container (20, 320) is closed. In embodiments wherein the closure (30, 330) is a rectangular frontal planar door, the rotating mechanisms (46, 346) may be so placed as to allow the door to open upwards, downwards, or to either side. Where a rotating mechanisms (46, 346) is used to attach the closure (30, 330) to the base (25, 325), a second engagement element (40, 340) may be used to secure the closure (30, 330) in a closed position and prevent unwanted rotation out of position.

Referring to FIGS. 1 through 8, and without limitation, the engagement elements (40, 140, 240, 340) may comprise latches, hasps, hasplocks, catches, or pins. Engagement elements (40, 140, 240, 340) on the closure (30, 130, 230, 330) engage counterpart engagement elements (42, 142, 242, 342) on the base (25, 125, 225, 325) when the security container (20, 120, 220, 320) is secured. Optionally, engagement elements (40, 140, 240, 340) are lockable, or accept a lock, or are attached to a lock (49, 149, 249, 349) to deter or delay unauthorized opening of the security container (20, 120, 220, 320). Without limitations, a lock (49, 149, 249, 349) may be a keyed lock, a combination lock, a mechanical lock, and electronic lock, a pad lock, an installed lock, or a trick lock.

Referring to FIGS. 1 through 8, because the security container (20, 120, 220, 320) is to be secured against intentional and accidental access to the interior (28, 128, 228, 328) of the base (25, 125, 225, 325), the security container (20, 120, 220, 320) closure (30, 130, 230, 330) should comprise durable materials. Without limitation, materials acceptable for use as the closure material include steel, aluminum, polymers, composite materials, concrete, and wood.

Referring to FIGS. 5 and 6, to the security unit may optionally include a cosmetic face (250) to the closure (230) of the security container (220). A cosmetic face (250) is intended to give the closure a particular appearance. Such appearance may be chosen for aesthetic or utilitarian concerns. To address aesthetic appearance concerns, the closure (230) may be painted a particular color or have a veneer layer applied over it. Without limitation, such aesthetic appearance cosmetic faces (250) may be designed to result in the security container (220) matching the styling of the appliance unit (260) to which it is conjoined. To address utilitarian appearance concerns, the closure (230) may again be painted a particular color or have a veneer layer applied over it. Referring to FIGS. 5 and 6, utilitarian appearance cosmetic faces (250) may be designed to result in the security container (220) being camouflaged as a type of appliance unit or compartment, as a further deterrent to theft.

Referring to FIGS. 1 through 8, the appliance unit (60, 160, 260, 360) which is conjoined with said security container (20, 120, 220, 320) may be an), common appliance. In certain embodiments, and without limitation, the appliance unit (60, 160, 260, 360) to which the security container (20, 120, 220, 320) is conjoined is of sufficient bulk or mass to discourage, delay, or prevent removal of the security unit (10) from a location. Without limitation, the appliance unit (60, 160, 260, 360) may be a refrigerator (65, 365), microwave oven (265), freezer (165), toaster oven, convection oven, dryer, washing machine, humidifier, dehumidifier, space heater, air conditioner, and dishwasher. It is to be understood that the appliance unit (60, 160, 260, 360) may be either of the conventional size or of the compact size. Without limitation, one example of a compact size appliance that may be the appliance unit (60, 160, 260, 360) is a dormitory refrigerator.

The means for conjoining the appliance unit and the security container (20, 120, 220, 320) may be any durable mechanical connection. Either the security container base (25, 125, 225, 325) or the security container closure (30, 130, 230, 330) may be the part of the security container (20, 120, 220, 320) durably connected to the appliance unit (60, 160, 260, 360). In certain embodiments, the base (25, 125, 225, 325) of the security container (20, 120, 220, 320) and the infrastructural frame of the appliance are made from a single integral piece of material. By way of illustration, but not limitation, the security container base (25, 125, 225, 325) may be formed from the same sheet of sheet metal used to form the frame elements of a refrigerator (60, 360). Similarly, in an appliance having, molded or cast construction elements, the security container base (25, 125, 225, 325) may be integrally formed from this material. In embodiments in which the security container (20, 120, 220, 320) and the infrastructural frame of the appliance are made from a single integral piece of material, separation of the security container (20, 120, 220, 320) from the appliance unit (60, 160, 260, 360) is an involved operation requiring considerable difficulty so as to discourage or delay removal.

In another embodiment, the base (25, 125, 225, 325) of the security, container (20, 120, 220, 320) and the frame of the appliance unit (60, 160, 260, 360) are connected using durable connection methods such as welding, brazing, soldering, or gluing. In embodiments in which the security container (20, 120, 220, 320) and the structural elements of the appliance unit (60, 160, 260, 360) are connected using durable connection methods, separation of the security container (20, 120, 220, 320) from the appliance unit (60, 160, 260, 360) is an involved operation requiring considerable difficulty so as to discourage or delay removal.

In another embodiment, the base (25, 125, 225, 325) of the security container (20, 120, 220, 320) and the frame of the appliance unit (60, 160, 260, 360) are connected using mechanical fasteners. Without limitation mechanical fasteners include tamper-proof fasteners, break-away fasteners, integral fasteners, conventional fasteners, and combinations thereof. Conventional fasteners include, without limitation, screws, bolts, nuts, pins, rods, clips, clamps, staples, nails, and brads. Integral fasteners are mechanical fasteners which are connected to the elements to be joined using connection methods such as, without limitation, welding, gluing, or pressing. Integral fasteners are a difficult to remove sub-element of the materials to be joined. Without limitation, a common integral fastener is a welded nut. A welded nut is welded to one of the elements to be joined thereby preventing the rotation of the nut with respect to the joined element. Use of a welded nut prevents easy disassembly of the joined items without access to the mating bolt. Tamper-proof fasteners are fasteners requiring a special tool to remove. Without limitation, common tamper-proof fasteners are spanner nuts and bolts and “pin-head” bolts. Break-away fasteners are fasteners which include a removable tool engagement surface that is removed after installation. Such removal prevents conventional tools from engagement with the fastener making such fasteners difficult to remove. In embodiments in which the security container (20, 120, 220, 320) and the infrastructural frame of the appliance unit (60, 160, 260, 360) are connected using tamper-proof, break-away, or integral fasteners, separation of the security container (20, 120, 220, 320) from the appliance unit (60, 160, 260, 360) is an involved operation requiring considerable difficulty so as to discourage or delay removal. In certain embodiments in which the security container (20, 120, 220, 320) and the appliance unit (60, 160, 260, 360) are connected using mechanical fasteners, the mechanical fasteners may be shrouded, covered, or otherwise placed to limit access to the mechanical fasteners. Without limitation, in certain embodiments, the fasteners may be shrouded or covered by having access to them only through the interior of the security container. Without limitation, in certain embodiments, the fasteners may be shrouded, covered, or protected by a cap, cover, hood, skirt, or washer to limit access to the fastener.

Referring to FIGS. 1 through 8, although the security unit (10) is shown in all illustrative embodiments with the security container (20, 120, 220, 320) located on top of the appliance unit (60, 160, 260, 360), this is not the only useful form. It should be understood that many forms may be used including, without limitation, placement of the appliance unit (60, 160, 260, 360) on top of the security container (20, 120, 220, 320), placement of the appliance unit (60, 160, 260, 360) beside the security container (20, 120, 220, 320), or placement of the appliance unit (60, 160, 260, 360) in front of the security container (20, 120, 220, 320).

Referring to FIGS. 1 through 8, although the security unit (10) is shown in all illustrative embodiments with a single security container (20, 120, 220, 320) and a single appliance unit (60, 160, 260, 360), this is not the only useful form. It should be understood that many forms may be used including, without limitation, one or more appliance units (60, 160, 260, 360) of the same or differing kind in conjunction with one or more security containers (20, 120, 220, 320) of the same or differing kind. Without limitation, in certain embodiments, the security unit comprises a compact refrigerator, a microwave oven, and a security container (20, 120, 220, 320).

While the security unit has been described above in connection with the illustrative embodiments, as shown in the various figures, it is to be understood that other similar embodiments may be used or modifications and additions may be made to the described embodiments for performing the same function. Further, all embodiments disclosed are not necessarily in the alternative, as various embodiments may be combined to provide the desired characteristics. Variations can be made by one having ordinary skill in the art without departing from the spirit and scope of the invention. Therefore, the security unit should not be limited to any single embodiment, but rather construed in breadth and scope in accordance with the recitation of the attached claims.

1. A security unit comprising:
at least one security container; and
at least one appliance unit conjoined with said security container.

2. The security unit of claim 1, wherein said security container comprises a base, a closure, and an engagement element for affixing said base to said closure.

3. The security unit of claim 2, wherein said engagement element lockably and releaseably attaches said closure to said base.

4. The security unit of claim 3, wherein said appliance unit is conjoined with said security container by an integral frame common to both said security container and said appliance unit.

5. The security unit of claim 3, wherein said appliance unit is conjoined with said security container by a joint comprising a welded connection between said security container and said appliance unit.

6. The security unit of claim 3, wherein said appliance unit is conjoined with said security container by a joint comprising a brazed connection between said security container and said appliance unit.

7. The security unit of claim 3, wherein said appliance unit is conjoined with said security container by a joint comprising a soldered connection between said security container and said appliance unit.

8. The security unit of claim 3, wherein said appliance unit is conjoined with said security container by a glued joint between said security container and said appliance unit.

9. The security unit of claim 3, wherein said appliance unit is conjoined with said security container by mechanical fasteners.

10. The security unit of claim 3, wherein said appliance unit is conjoined with said security container by break-away fasteners.

11. The security unit of claim 3, wherein said appliance unit is conjoined with said security container by integral fasteners.

12. The security unit of claim 3, wherein said appliance unit is conjoined with said security container b) tamper-proof fasteners.

13. The security unit of claim 4, wherein said integral frame is comprised of a material selected from the group consisting of metal, metal alloys, plastic, composite materials, wood, and combinations thereof.

14. The security unit of claim 13, wherein the said integral frame is comprised of a material selected from the group consisting of steel, aluminum, aluminum alloys, and combinations thereof.

15. The security unit of claim 14, wherein the said engagement element is selected from the group consisting of an integral lock, an integral latch, a hasp, a catch, a pin, and combinations thereof.

16. The security unit of claim 15, wherein the said engagement element is selected from the group consisting of a keyed lock, a mechanical combination lock, and an electronic combination lock.

17. The security unit of claim 16, wherein the said closure is affixed to said base by a mechanism selected from the group consisting of sliding mechanisms, tracks, rotating mechanisms, hinges, and combinations thereof.

18. The security unit of claim 17, wherein said mechanism comprises a hinge.

19. The security unit of claim 1, wherein the appliance unit is selected from the group consisting of refrigerator, microwave oven, freezer, toaster oven, convection oven, dryer, washing machine, humidifier, dehumidifier, space heater, air conditioner, and dishwasher.

20. The security unit of claim 19, wherein the appliance unit comprises a refrigerator.

21. The security unit of claim 19, wherein the refrigerator has between about 1 and about 6 cubic feet of interior storage space.

22. The security unit of claim 1, wherein the security container is substantially fireproof.

23. The security unit of claim 1, wherein the security container is substantially waterproof.

24. The security unit of claim 1 comprising a security container and two appliances.

25. The security unit of claim 24 comprising two appliances conjoined to said security container wherein a first appliance unit comprises a refrigerator and wherein a second appliance unit comprises a microwave oven.

26. The security unit of claim 25, wherein the security container is substantially waterproof and fireproof and wherein said appliances and security container are conjoined by an integral steel frame common to said security container and said appliances.
